(19) United States
(12) Patent Application Publication
(10) Pub. No.: US 2009/0165805 A1
(43) Pub. Date: Jul. 2, 2009

(54) Mouth Guard

(75) Inventors: Steven B. Syrop, Chappaqua, NY (US); Donald R. Tanenbaum, Great Neck, NY (US)

Correspondence Address: MYERS WOLIN, LLC, 100 HEADQUARTERS PLAZA, North Tower, 6th Floor, MORRISTOWN, NJ, 07960-6834, US

(73) Assignee: ORAL TECHNOLOGY, LLC, New York, NY (US)

(21) Appl. No.: 11/967,216

(22) Filed: Dec. 30, 2007

(51) Int. Cl. A61C 5/14

(52) U.S. Cl. 128/861

(57) ABSTRACT

A mouth guard comprises, in one embodiment, a pair of bite pads joined by a connecting portion, each bite pad having an upper bite surface and a lower bite surface, one bite surface being movable relative to the other bite surface to allow relative movement of a user's teeth and jaws to decrease the impact of bruxism and diminish symptoms associated with temporomandibular disorders and the like. In another embodiment, a single wire is formed into a mouth guard comprising a pair of bite pads joined by a connection portion.

### FIELD OF THE INVENTION

The present invention relates to mouth guards in general, and more specifically to a mouth guard that allows for relative movement of a user's upper and lower jaw during use to alleviate jaw strain and problems associated with bruxism and the like.

### BACKGROUND

Mouth guards typically worn by athletes tend to be U-shaped and bulky, encompassing the entire oral cavity. However, mouthpieces which provide protection for the upper and lower teeth, and which are commonly used in contact sports, have the disadvantage of interfering with speaking and breathing, and can be uncomfortable. Another disadvantage with this type of mouthpiece is that obtaining a proper fit for a particular user's mouth with standard sizes can be difficult.

Similar U-shaped mouth guards are provided for decreasing the impact of bruxism and diminish symptoms associated with temporomandibular disorders and the like, and are intended to be worn overnight. These mouth guards typically separate the teeth so as to diminish the damaging tooth-on-tooth contact that occurs while the user is sleeping. In addition, some guards fix the upper and lower jaws in place to prevent unwanted movement related to TMJ or the like. As with athletic guards, obtaining a proper fit can be a problem. Most dentists provide an option to have a custom-fit mouth guard, which requires an initial fitting at the dental office followed by a manufacturing time delay and a second office visit to receive the guard, which is comparatively expensive relative to over-the-counter solutions. Typical over-the-counter solutions require a so-called “boil and bite” fit, where a plastic mouth piece is first softened by boiling, and then fit to a user's mouth by biting to form customized tooth impressions at the appropriate locations. Again, however, these types of mouth pieces tend to interfere with speaking and breathing, and can be uncomfortable to wear.

Other mouth guard solutions take up less room in the oral cavity and typically focus on isolating the molar regions, one example being U.S. Pat. No. 5,873,365. However, while these types of mouth guards typically function to separate the teeth to prevent undesirable clenching or grinding contact or the like, they usually provide a relatively fixed bite pad or biting surface. Thus, instead of grinding the teeth together, the user typically grinds across the bite pad, which can cause the mouth guard to move or otherwise become dislodged from the oral cavity during the overnight.

There is a need, therefore, for a mouth guard that accommodates the movement of a user's teeth and jaws while protecting the same from undesirable contact, decreasing the impact of bruxism, and diminishing the symptoms of temporomandibular disorders and the like.

### SUMMARY

A mouth guard comprises, in one embodiment, a pair of bite pads joined by a connecting portion, each bite pad having an upper bite surface and a lower bite surface, one bite surface being movable relative to the other bite surface to allow relative movement of a user's teeth and jaws thereby decreasing the impact of bruxism and diminishing the symptoms of temporomandibular disorders and the like. In another embodiment, a single wire is formed into a mouth guard comprising a pair of bite pads joined by a connection portion

### BRIEF DESCRIPTION OF THE DRAWINGS

FIG. 1 is a perspective view of one embodiment of a mouth guard of the present invention.

FIG. 2 is a rear edge view of the mouth guard of FIG. 1.

FIG. 3 is front view of a bite pad in accordance with one embodiment of the invention.

FIG. 4 is front view of a bite pad in accordance with an alternative embodiment of the invention.

FIG. 5 is front view of a bite pad in accordance with an alternative embodiment of the invention.

FIG. 6 illustrates positioning of the mouth guard of FIG. 1 relative to a user's teeth.

FIG. 7 illustrates movement of portions of the mouth guard of FIG. 1 during use.

FIG. 8 is a perspective view of an alternative embodiment of a mouth guard of the present invention.

FIG. 9 is a cross-section taken through line 9-9 of FIG. 8.

FIG. 10 is a perspective view of an alternative embodiment of a mouth guard of the present invention.

FIG. 11 is an exploded, perspective view of an alternative embodiment of a mouth guard of the present invention.

FIG. 12 is a cross-section taken through line 12-12 of FIG. 11.

FIG. 13 is a top view of the mouth guard of FIG. 11.

FIG. 14A is a perspective view of an alternative embodiment of a mouth guard of the present invention.

FIG. 14B is a perspective view of an alternative embodiment of a mouth guard of the present invention.

FIG. 15 is a perspective view of an alternative embodiment of a mouth guard of the present invention.

FIG. 16 illustrates use of the mouth guard of FIG. 15.

FIG. 17 is a cross-section taken through line 17-17 of FIG. 15.

FIG. 18 is a perspective view of an alternative embodiment of a mouth guard of the present invention.

### DETAILED DESCRIPTION OF THE PREFERRED EMBODIMENTS

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

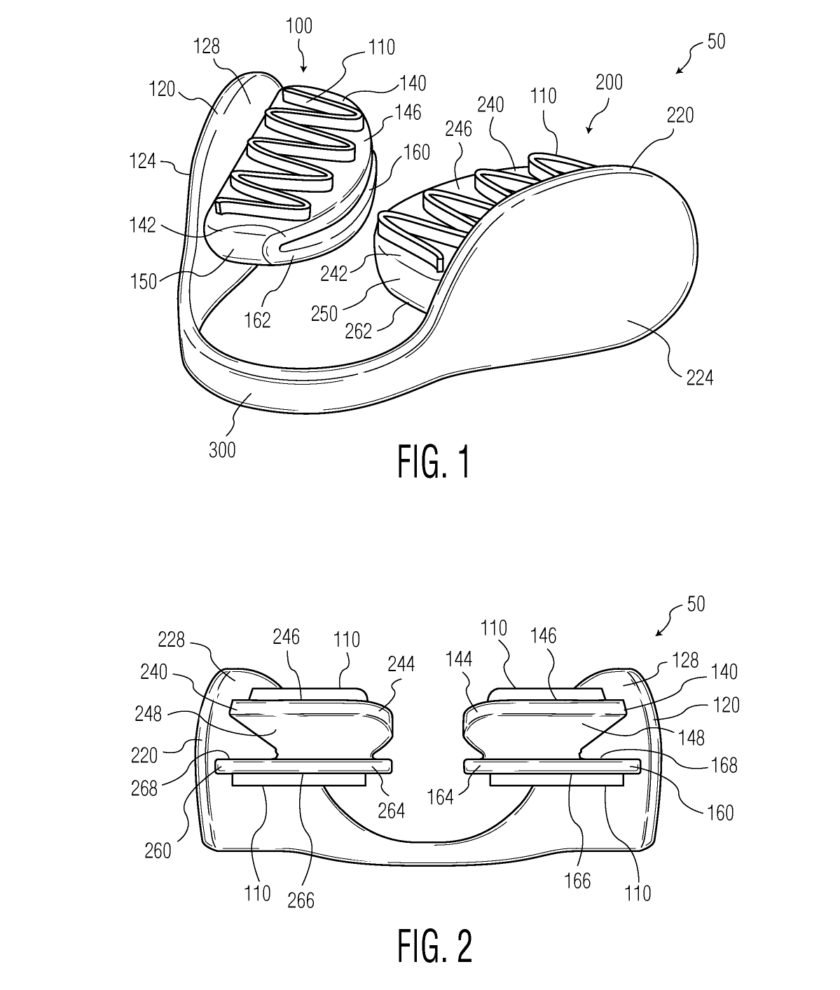

FIG. 1 is a perspective view and FIG. 2 is a rear edge view of one embodiment of a mouth guard 50 comprising a first portion 100, a second portion 200 and a connecting portion 300 extending therebetween. The first and second portions 100, 200 respectively further comprise a cheek-engaging portion 120, 220, an upper bite pad 140, 240, and a lower bite pad 160, 260. The cheek-engaging portion 120, 220 further comprises a cheek-engaging outer surface 124, 224 and an inner surface 128, 228. The upper bite pads 140, 240 respectively further comprise a first end 142, 242 and a second end 144, 244, the first end 142, 242 located nearer the connecting portion 300 than the second end 144, 244. Similarly, the lower bite pads 160, 260 respectively further comprise a first end 162, 262 and a second end 164, 264. The upper and lower bite pads respectively further comprise upper and lower bite surfaces 146, 246 and 166, 266, as well as inner surfaces 148, 248 and 168, 268 shown more clearly in FIG. 2.

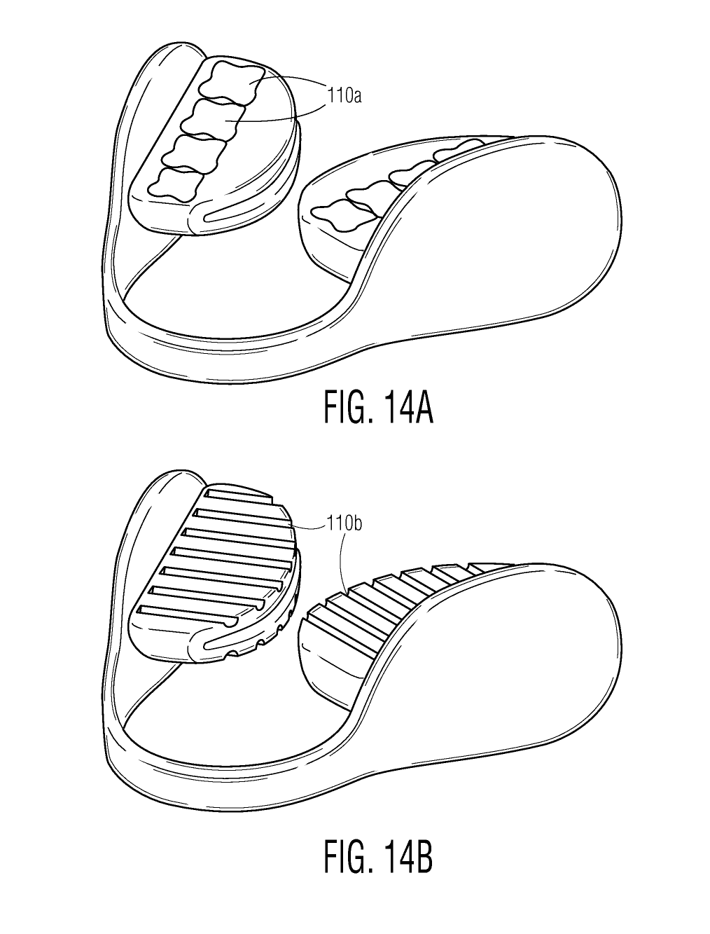

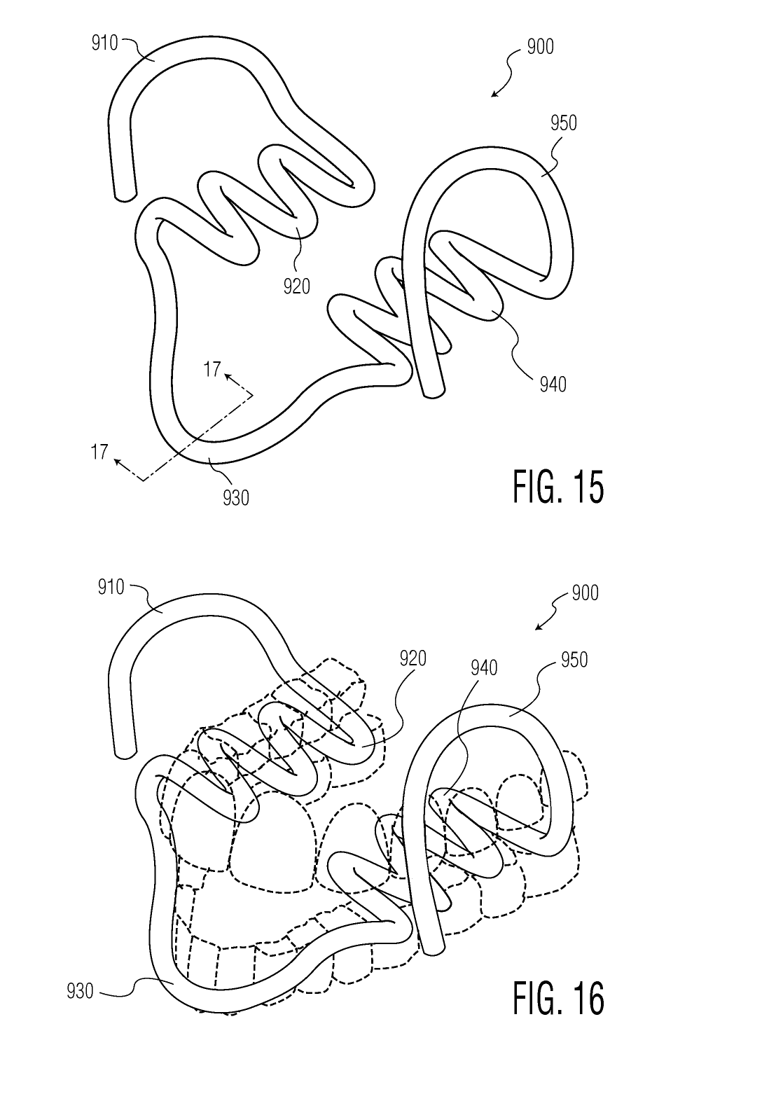

The bite surfaces are preferably provided with a cushioning texture or contour 110 to provide a more comfortable experience for the user. Such texture also preferably aids in maintaining the user's teeth in gripping contact with the bite surfaces, while at the same time reducing the surface area in contact with the teeth. The embodiment of FIGS. 1-3, for example, shows one possible construction of a texture 110 in the nature of a repeating, multi-directional contour that is sinusoidal in shape. The texture 110 is further constructed as a raised, deformable wall of rectangular cross-section to provide a cushion-like feel for the user. Other texture constructions having other shapes, dimensions, orientations and cross-sections, for example, are contemplated, with one such non-limiting example in the nature of tooth impressions 110a shown for example in FIG. 14A, and with another such non-limiting example in the nature of grooves 110b shown for example in FIG. 14B.

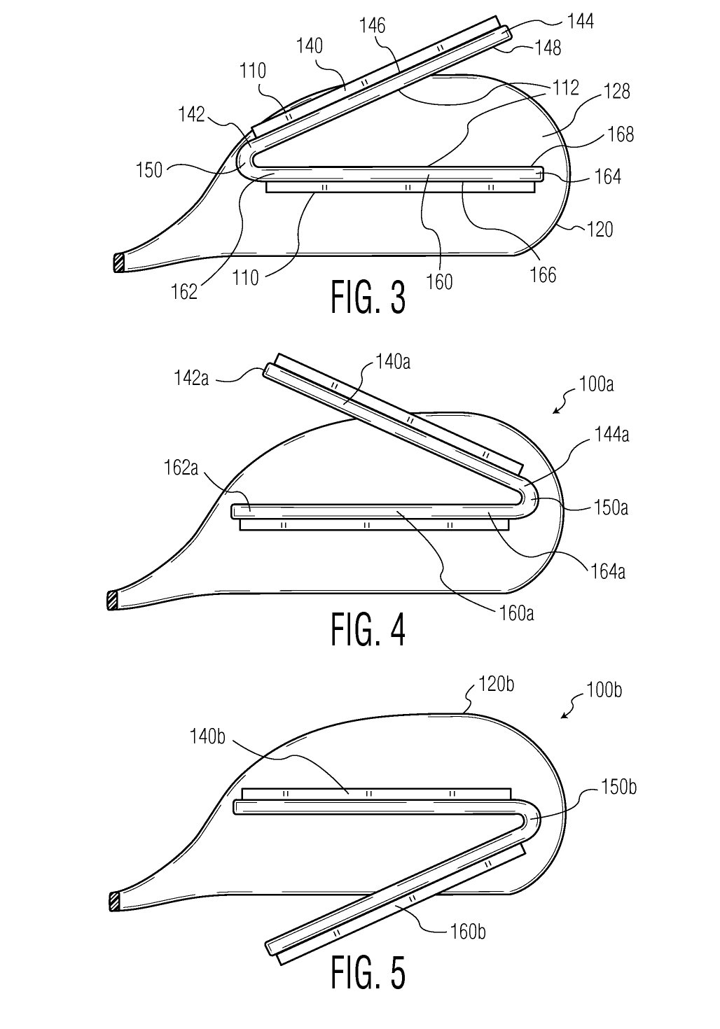

In the embodiment of FIGS. 1 and 2, the first end 142, 242 of the upper bite pads 140, 240 and lower bite pads 160, 260 are preferably attached at a hinge 150, 250, with the second ends 144, 164, 244, 264 comprising free ends of the upper and lower bite pads, to form V-shaped bite pads as shown for example in FIG. 2 and FIG. 3. Alternatively, as shown in FIG. 4 representing an alternative illustration of the first portion 100a, it being understood that the second portion (not shown) is consistent with the differences mentioned in connection with first portion 100a, the second ends 144a, 164a of upper and lower bite pads 140, 160a could be attached at a hinge 150a, with the first ends 142a, 162a comprising free ends of the upper and lower bite pads 140a, 160a. However, for purposes of explanation, the hinge 150, 250 shall be described herein as joining the first ends 142, 162 and 242, 262 as illustrated in FIGS. 1-3.

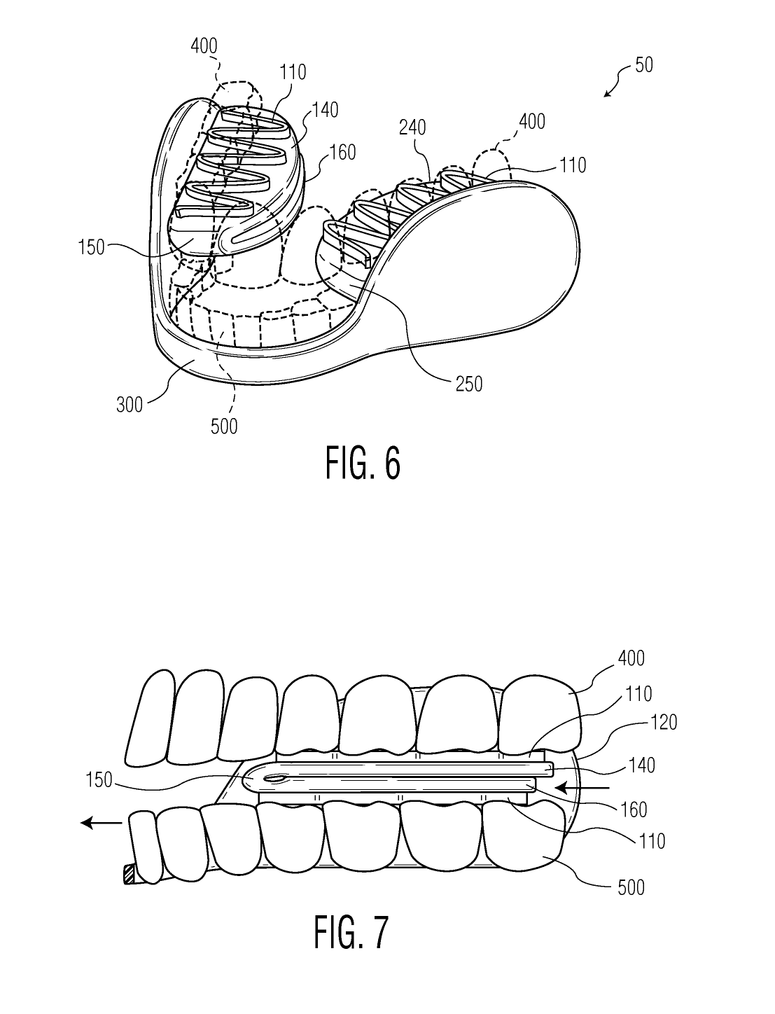

Returning to the embodiment of FIGS. 1-3, the upper bite pad 140, 240 is movable relative to the lower bite pad 160, 260 via the hinge 150, 250 with the upper bite pad 140, 240 preferably being movable relative to the cheek-engaging portion 120, 220, and the lower bite pad 160, 260 preferably being fixed in position relative to the cheek-engaging portion 120, 220. Alternatively, as shown in FIG. 5 representing an alternative illustration of the first portion 100b, it being understood that the second portion (not shown) is consistent with the differences mentioned in connection with first portion 100a, the lower bite pad 160b is movable relative to the upper bite pad 140b via the hinge 150b, with the lower bite pad 160b preferably being movable relative to the cheek-engaging portion 120b, and the upper bite pad 140b preferably being fixed in position relative to the cheek-engaging portion 120b. However, for purposes of explanation, the upper bite pad 140, 240 shall be described herein as being movable relative to the lower bite pad 160, 260 as illustrated in FIGS. 1-3. In addition, while the upper and lower bite pads of FIGS. 2-5 are shown in an angled “V” relationship with respect to each other, such angle can vary from very small such that the bite pads are substantially parallel at rest as shown in FIG. 6 and some of the later figures, or such angle can be larger at rest as shown in FIGS. 2-5.

FIGS. 6 and 7 illustrate positioning and use of the mouth guard 50 of the embodiment of FIGS. 1-3. A user places the mouth guard 50 into the mouth and bites down on the bite pads such that the upper teeth 400 contact the upper bite pads 140, 240, the lower teeth 500 contact the lower bite pads 160, 260, and the inner surfaces 148, 168 and 248, 268 meet. Preferably, the upper and lower molar regions will contact the texture 110 provided on the upper and lower bite pads respectively, and the connecting section 300 will be positioned around the lower incisors and canines as shown in FIG. 6. As the user clenches and grinds as shown for example in FIG. 7, with the lower jaw and teeth 500 advancing forward relative to the upper jaw and teeth, for example, the inner surfaces 148, 168 and 248, 268 slide against each other and the lower bite pad 160, 260 moves forward relative to the upper bite pad 140, 240 via the hinge 150, 250 to diminish forces being applied to the jaws and teeth that might otherwise occur if the jaws and teeth are locked in position during clenching and grinding. The texture or contour 110 absorbs the normal impact of the user's teeth upon the bite pads, while the hinge and the movement provided thereby in the bite pads absorbs the lateral or translational movement of the user's jaws and teeth. One or each of the inner surfaces 148, 168, 248, 268 are preferably lined with a friction-reducing material 112 (see FIG. 3) to facilitate relative sliding contact of the inner surfaces. Such friction-reducing material 112 results in a lower coefficient of friction on the inner surfaces than on the bite surfaces and preferably takes the form of a separate material layer adhered or otherwise applied to the inner surfaces of the bite pads that allows the bite pads to slip and slide relative to each other. Alternatively, the inner surfaces can be manufactured to have a slicker feel without the need for a separately applied layer. Thus, the mouth guard of the present embodiment does not restrict or otherwise impair the natural movement of a user's jaws and teeth, and therefore diminishes forces on the jaws and teeth and other problems associated with mouth guards that fix the jaws and teeth in position.

The mouth guard 50 is preferably fabricated from a resilient, polymeric material that can be injection molded, stamped, vacuum formed, or otherwise manufactured. For example, ethylene vinyl acetate (EVA) has been found to be a suitable material. Other materials include, but are not limited to an elastomer, FDA grade silicone, silicone rubber, synthetic rubber, silicone resin or thermoplastic resin, and other FDA grade materials commonly used for mouth guards and mouth pieces and the like. Preferably, such materials should have a softening point that is higher than human body temperature but below the boiling point of water, particularly if it is desired to bite mold tooth impressions into the bite pads. However, other materials with the desired characteristics of resiliency, flexibility and durability may be utilized. Moreover, the hardness of the materials can be controlled to provide desired performance characteristics. From an aesthetic viewpoint, the mouth guard can be clear or translucent in a typical fashion, or fancifully decorated to appeal to a younger audience. Furthermore, the mouth guard of the present embodiments may be disposable, and formed from materials that are best suited for short-term use.

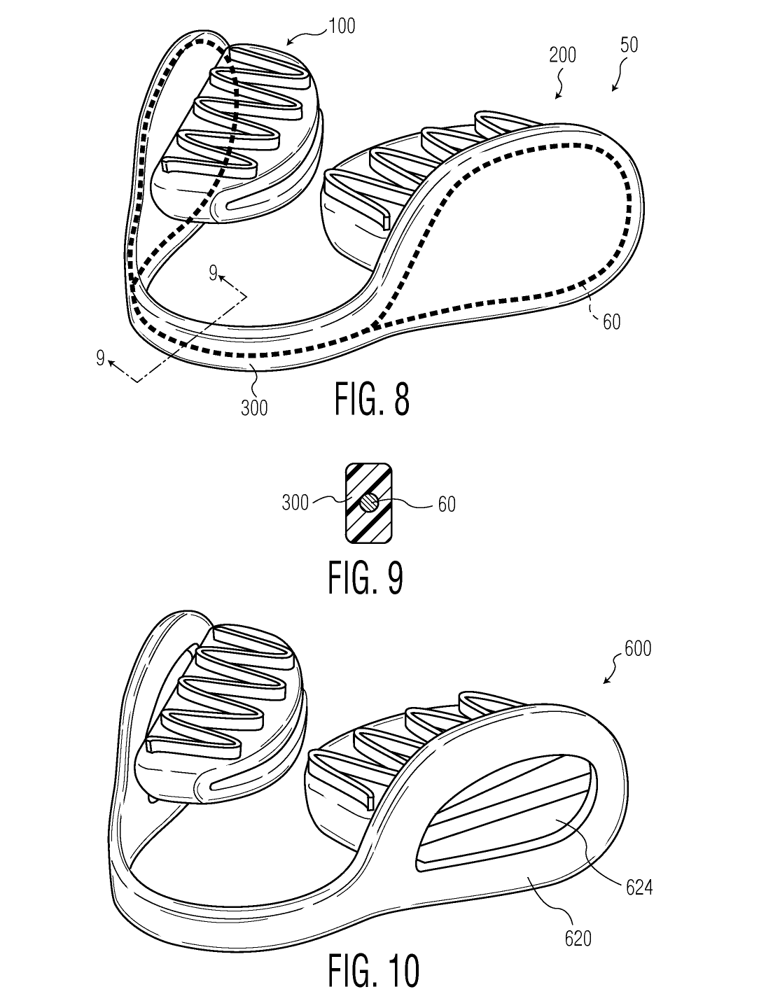

One manufacturing technique involves initially molding the mouth guard 50 in a flat or outstretched position such that the first portion 100, second portion 200 and connecting portion 300 are laid out in the same plane (not shown). To form the curved overall shape of the mouth guard and to provide additional structural support during use and non-use conditions, a wire support 60 (FIGS. 8 and 9) is preferably embedded or insert molded along the peripheral edges of the mouth guard. Such wire support 60 is preferably formed from stainless steel, although other materials are contemplated, and having a thickness of around twenty-four gauge, although other dimensions are contemplated. The wire support 60 could also be formed as a wire mesh that is even more moldable than a solid or hollow wire. The wire support 60 should be dimensioned to function as a structural support to enable the user to bend and mold the guard into a desired curvature or configuration, with the understanding that a wire that is too thin will fail to maintain the mouth guard in a formed position over time. The wire is preferably a dead soft wire with little or no memory allowing it to mold and conform to each user's mouth giving a customized fit, which is preferable over other oral appliances which depend upon “boil and bite” customization that are settable with memory. Thus, the mouth guard of the present embodiments can be vended in a flat condition, which enables the use of more efficient packaging for multi-unit offerings.

FIG. 10 illustrates an alternative embodiment of a mouth guard 600 similar to the mouth guard embodiment 50 of FIGS. 1-3, but with cheek-engaging portions 620 having openings 624 to reduce material weight and create more of an open construction. An open construction is preferable to allow for greater saliva and airflow through the mouth guard. In addition, if a wire or the like (FIGS. 8-9) is used to provide structural support to the overall periphery of the mouth guard 600, then the existence of voids or openings 624 should not impair the malleability or structural integrity of the mouth guard during use or non-use conditions.

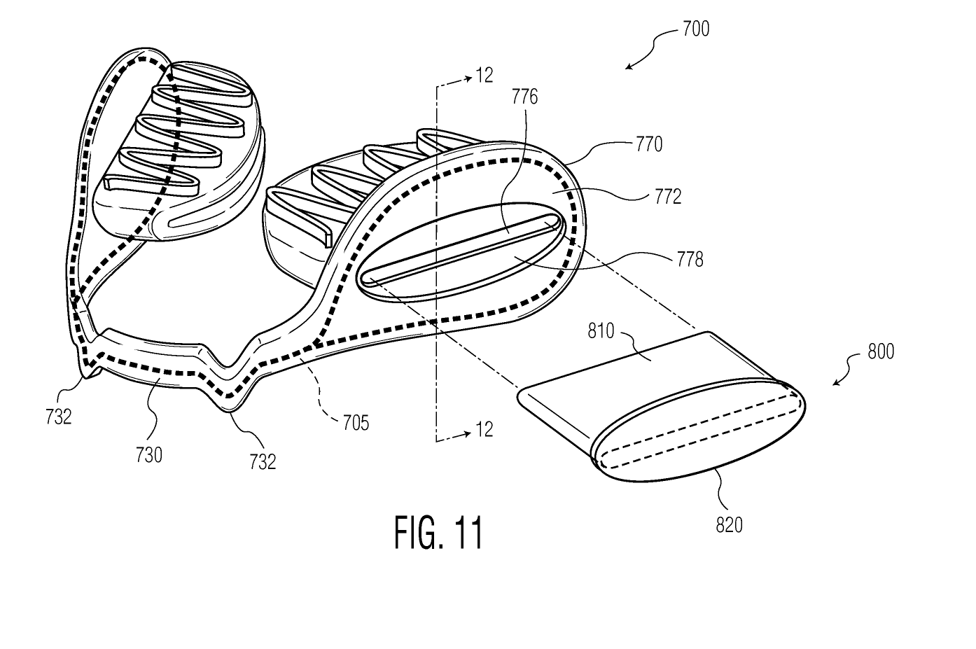

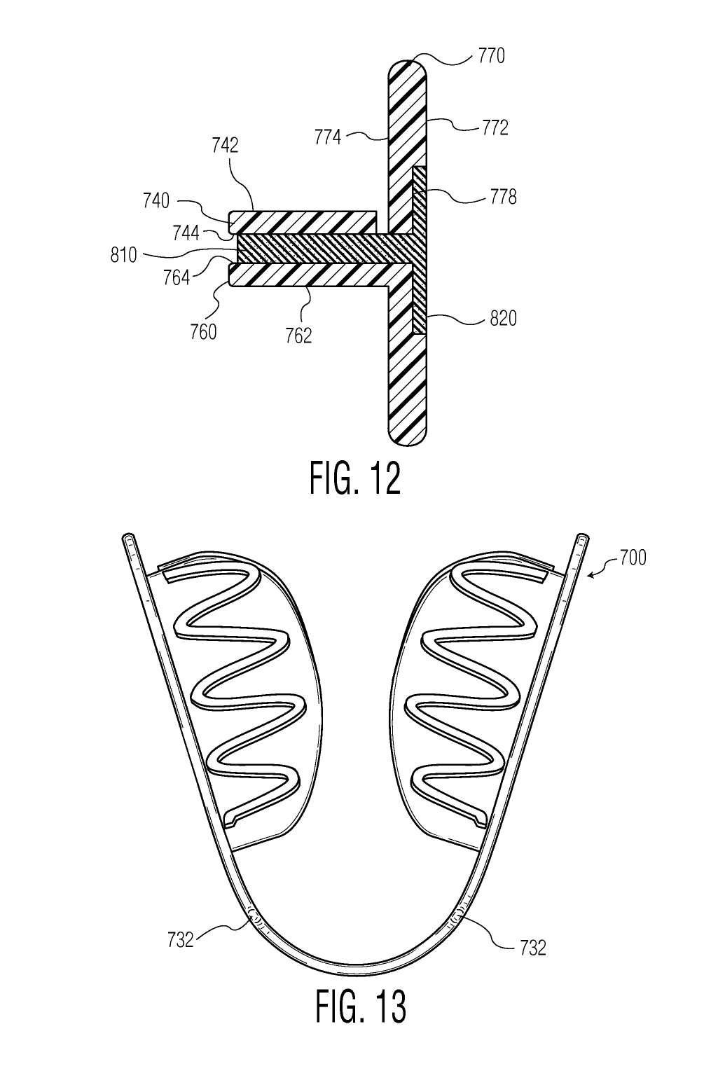

FIGS. 11-13 illustrate an alternative embodiment of a mouth guard 700 similar to the embodiment 600 of FIG. 10. For purposes of explanation, only one side of the mouth guard 700 will be described with the understanding that the other side is a mirror image. Mouth guard 700 further comprises a cheek-engaging portion 770 having an outer surface 772 and an inner surface 774, an upper bite pad 740 having an outer surface 742 and an inner surface 744, a lower bite pad 760 having an outer surface 762 and an inner surface 764, a structural wire support 705 of the type described in connection with FIG. 8, and a connecting section 730 having length-adjusting notches 732 formed therein. The notches 732 enable a user to shorten or lengthen the connecting section 730, and therefore the overall length of the mouth guard, to accommodate oral cavities of different sizes. An opening 776 having a recessed seat 778 is formed in the cheek-engaging portion 770 to allow for the passage of a lateral extension 810 of a cushion 800 into position between the inner surfaces 744, 764 of the bite pads 740, 760. The cushion 800 further comprises a support portion 820 that is seated within the recessed seat 778 of the opening 776 to prevent the cushion 800 from completely passing through the opening 776. The cushion 800 provides additional thickness between the upper and lower bite pads to accommodate particularly aggressive clenching. The cushion 800 is preferably an optional component that is inserted through the cheek-engaging portion 770 if desired to be worn by the user, otherwise the cushion 800 may be removed.

The embodiments of the mouth guard described above are particularly suited for nighttime use when it is not necessary, for example, to engage in lengthy conversation or the like. Furthermore, while the embodiments described above are generally of a simplified construction relative to bulky U-shaped athletic mouth guards, for example, an even more simplified construction is presented in connection with the mouth guard embodiments 900 and 900a of FIGS. 15-18. As will be described in more detail below, the embodiments 900 and 900a of FIGS. 15-18 are particularly suited for daytime use when it might be necessary to engage in normal conversation and the like.

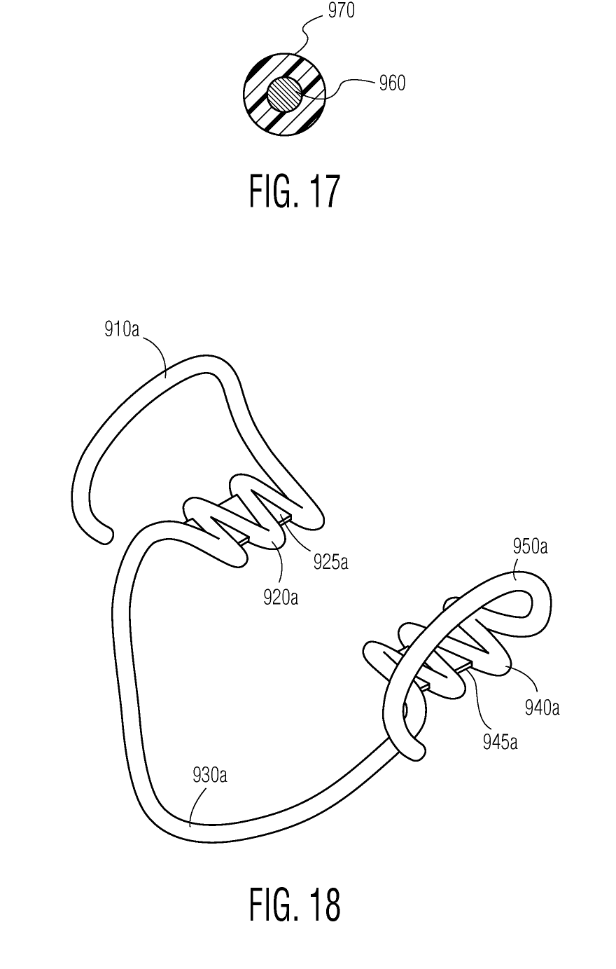

Mouth guard 900 (FIGS. 15-17) further comprises a first cheek-engaging portion 910 connected to a first bite pad 920, which is connected to a connecting section 930, which is connected to a second bite pad 940, which is connected to a second cheek-engaging portion 950. More particularly, mouth guard 900 further comprises a single, continuous shapeable core or wire 960 encased in a protective covering 970 (FIG. 17) that is shaped to form the aforementioned portions 910-950 and that is intended to be worn (FIG. 16) in a similar manner to the mouth guard embodiment of FIGS. 1-3 as shown in FIG. 6 for example. The bite pads 920 and 940 further comprise upper and lower biting surfaces that function to separate the upper and lower teeth to prevent teeth clenching, bruxism and the like, while the cheek-engaging portions 910, 950 and the connecting portion 930 function to position and stabilize the mouth guard 800 within the oral cavity and against the teeth of a user. The connecting portion 930 in particular is oriented against the anterior portion of the mandible during use.

In the embodiment 900, the bite pads 920 and 940 are formed from open, multi-directional contours that are sinusoidal in shape, similar to the contour or texture 110 from FIGS. 1-3 for example. The sinusoidal profile is convenient because it provides a somewhat continuous platform for the user's teeth within an overall compact structural arrangement. However, because the bite pads of the embodiment of mouth guard 900 also comprise an open construction, the user is able to upwardly and downwardly manipulate portions of the bite pads during use to create a custom fit before and during use. The cheek-engaging portions 910, 950 are orthogonally arranged relative to the bite pads and comprise a substantially open construction for providing direct access to the bite pads, which enable improved air flow and saliva flow around and about the mouth guard 900. Of course, other bite pad configurations, shapes and constructions are contemplated, one being shown in the mouth guard embodiment 900a of FIG. 18.

Mouth guard 900a (FIG. 18) comprises cheek-engaging portions 910a, 950a, a connecting portion 930a, and bite pads 920a and 940a that are connected by web portions 925a, 945a that render the bite pads 920a, 940a stiffer than the mouth guard embodiment 900 of FIGS. 15-17. Such web portions 925a, 945a may be attached to the bite pads 920a, 940a in a post-processing step using ultrasonic welding or the like, or the web portions may be molded together with the rest of the mouth guard 900a in a single injection-molding (or the like) manufacturing step. The web portions 925a, 945a contribute additional surface area and torsional stability to the bite pads 920a, 940a, which may be more comfortable for certain users. The web portions also fix the structure of the bite pads 920a, 940a so that the bite pads are not susceptible to being inadvertently manipulated completely out of shape.

The mouth guards 900, 900a are preferably fabricated from a malleable wire 960 such as, but not limited to, stainless steel or the like, that is encased in a protective covering formed from, but not limited to, rubber or silicone for example. Such wire can be solid, hollow, a wire mesh or the like, or a combination of the same. The wire is preferably initially computer-formed to the shape as shown in FIGS. 15-18, and is then tweaked or further shaped by a dentist or other dental professional to conform to a particular user's oral cavity. Alternatively, the user can modify the shape of the mouth guards 900, 900a as desired without professional assistance.

A user places the mouth guard 900, 900a into the mouth and bites down on the bite pads such that the upper and lower teeth contact the bite pads. Preferably, the upper and lower molar regions will contact the bite pads while the connecting section will be positioned against the anterior portion of the mandible as shown in FIG. 16. As the user clenches and grinds, the user's teeth compress against the bite pads 920, 940 (920a, 940a) during clenching and ride along the same during grinding. The bite pads are not slidably movable like with the embodiment of FIG. 1-3 for example. However, the sinusoidal nature of the bite pads tends to facilitate sliding movement of a user's teeth across the same.

As with the earlier mouth guard embodiments, the mouth guard 900, 900a may be constructed to be disposable. In addition, because the mouth guard 900, 900a is preferably only formed from a single continuous wire, it is remarkably lightweight and comfortable to use.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A mouth guard comprising:
a) a first portion, a second portion and a connecting portion extending therebetween; and
b) each of said first and second portions further comprising a cheek-engaging portion, an upper bite pad and a lower bite pad respectively;
c) the upper and lower bite pads each further comprising a first end and a second end, the first end located nearer the connecting portion than the second end;
d) wherein the upper and lower bite pads are attached at a hinge; and
e) wherein at least one of the upper and lower bite pads is movable relative to the other bite pad via the hinge.

2. The mouth guard of claim 1, wherein at least one of the upper and lower bite pads is slidably movable relative to the other bite pad.

3. The mouth guard of claim 1, wherein the hinge connects the first end of each bite pad.

4. The mouth guard of claim 3, wherein the second end of each bite pad is a free end.

5. The mouth guard of claim 1, wherein at least one of the upper and lower bite pads is movable relative to the other bite pad and relative to the cheek-engaging portion, and the other bite pad is fixed relative to the cheek-engaging portion.

6. The mouth guard of claim 1, the upper and lower bite pads further comprising a multi-directional, bite surface contour.

7. The mouth guard of claim 1, the upper and lower bite pads further comprising a grooved contour.

8. The mouth guard of claim 7, wherein the grooved contour is recessed relative to an outer bite surface of the bite pads.

9. The mouth guard of claim 1, further comprising a support wire extending between the first portion, the second portion and the connecting portion.

10. The mouth guard of claim 1, each upper and lower bite pad further comprising an outer tooth-engaging surface and an inner surface, and further comprising a friction reducer provided on at least one inner surface to facilitate relative sliding movement between the inner surfaces.

11. The mouth guard of claim 1, each upper and lower bite pad further comprising an outer tooth-engaging surface and an inner surface, the inner surfaces further comprising a lower coefficient of friction than the outer tooth-engaging surfaces.

12. The mouth guard of claim 1, further comprising a cushion inserted in between the upper and lower bite paid.

13. The mouth guard of claim 12, wherein a portion of the cushion is seated in a notch in the cheek-engaging portion.

14. The mouth guard of claim 1, the connecting portion further comprising at least one length-adjusting notch.

15. A mouth guard comprising:
a) a pair of cheek-engaging portions joined by a connecting portion;
b) each cheek-engaging portion further comprising a bite pad having an upper bite surface and a lower bite surface, one bite surface being movable and the other bite surface being fixed relative to the cheek-engaging portion.

16. The mouth guard of claim 15, wherein the upper bite surface and lower bite surface are connected at one end to form a V-shaped bite pad.

17. The mouth guard of claim 15, one bite surface being slidably movable relative to the other bite surface during use.

18. A mouth guard comprising:
a) a first portion, a second portion and a connecting portion extending therebetween;
b) each of said first and second portions further comprising a cheek-engaging portion, an upper bite surface and a lower bite surface respectively; and
c) the upper and lower bite surfaces further comprising a repeating, multi-directional contour.

19. The mouth guard of claim 18, wherein the repeating, multi-directional contour further comprises a sinusoidal bite-engaging portion.

20. The mouth guard of claim 18, wherein the cheek-engaging portion further comprises an open construction for access to the bite surfaces.

21. A mouth guard comprising:
a) a first portion, a second portion and a connecting portion extending therebetween;
b) each of said first and second portions further comprising an upper bite surface and a lower bite surface; and
c) wherein the bite surfaces and connecting portion are formed from a single, continuous wire.

22. The mouth guard of claim 21, wherein the wire further comprises a shapeable core surrounded by a protective covering.

23. The mouth guard of claim 21, each of the first and second portions further comprising a cheek-engaging portion that is orthogonally arranged relative to the bite surfaces.

24. The mouth guard of claim 23, wherein the cheek-engaging portions, bite surfaces and connecting portion are formed from a single, continuous wire.

25. The mouth guard of claim 21, the upper and lower bite surfaces further comprising a multi-directional contour.

26. The mouth guard of claim 25, wherein the multi-directional contour further comprises a sinusoidal bite-engaging portion.

27. The mouth guard of claim 26, wherein the multi-directional contour further comprises connecting portions that improve torsional stability of the bite surfaces.

28. The mouth guard of claim 21, wherein the wire further comprises a dead soft wire with little or no memory.

29. The mouth guard of claim 21, wherein the wire further comprises a wire mesh.
